(19) United States
(12) Patent Application Publication
(10) Pub. No.: US 2026/0301714 A1
(43) Pub. Date: Oct. 1, 2026

(54) KEYBOARD DEVICE FOR KEYBOARD MUSICAL INSTRUMENT

(71) Applicant: KABUSHIKI KAISHA KAWAI GAKKI SEISAKUSHO, Hamamatsu-shi (JP)

(72) Inventor: Masahiko IWASE, Hamamatsu-shi (JP)

(21) Appl. No.: 19/631,609

(22) Filed: Mar. 27, 2026

(30) Foreign Application Priority Data
Mar. 31, 2025 (JP) 2024-059010

(51) Int. Cl. G10C 3/12; G10H 1/34

(52) U.S. Cl. CPC G10C 3/12; G10H 1/346; G10H 2220/311; G10H 2230/065

(57) ABSTRACT

Provided are a key which extends in a front-rear direction and is swingable, an action unit which is provided at a rear portion of the key and executes a predetermined action in conjunction with key depression, a hammer which is placed on the action unit and is driven upward via the action unit along with the key depression, and a keyboard pillow which supports a rear end portion of the key from below in a key release state. The action unit includes a holder fixed to the key, and a repetition lever and a jack turnably attached to the holder. The keyboard pillow has an inclined surface on which an abutment projection portion of the holder abuts from above.

### BACKGROUND

### Technical Field

The present invention relates to a keyboard device for a keyboard musical instrument such as an electronic piano, and particularly relates to a keyboard device for a keyboard musical instrument that achieves a similar action to that of a grand piano.

### Related Art

Conventionally, as a keyboard device of this type, for example, a keyboard device described in JP 2024-93320 A already filed by the present applicant is known. The keyboard device has a key that extends in the front-rear direction and is swingable with the center in the length direction as a fulcrum, and an action unit that executes a predetermined action in conjunction with key depression is attached to the rear portion of the key. The action unit includes a holder attached to the key, and a repetition lever and a jack turnably supported by the holder. The repetition lever is formed to have a predetermined shape extending in the front-rear direction, is turnably supported by the holder via a fitting hole provided at the front portion and penetrating in the right-left direction, and is provided on the rear side of the fitting hole with a jack guide hole penetrating in the up-down direction. On the other hand, the jack is turnably supported by the holder via a fitting hole provided at the lower portion and penetrating in the right-left direction, and includes a hammer push-up portion and a rear arm extending upward and rearward from the fitting hole, respectively. The hammer push-up portion is engaged in a state of being inserted into the jack guide hole of the repetition lever from below.

In addition, a hammer support is disposed on the rear side of the key, and the hammer extending in the front-rear direction is supported on the hammer support at the rear end thereof so as to be turnable in the up-down direction. The hammer has a hammer protrusion portion protruding downward at the rear portion thereof, and the hammer protrusion portion is placed on the upper side of the jack guide hole on the upper surface of the repetition lever.

Furthermore, a rear rail of a keyboard chassis extending in the right-left direction in a state of housing the hammer support is provided at the lower portion of the hammer support. The rear rail includes a housing recess portion that houses the lower portion of the hammer support, and a cushion placement portion which is bent at a right angle from the upper end portion of the front plate portion of the housing recess portion and extends horizontally forward, and to which a cushion extending in the right-left direction is attached. In the key release state, this cushion placement portion is contacted by the projection portion of the lower surface rear portion of the holder in the action unit of each key from above via the cushion, and functions as a so-called keyboard pillow.

In the keyboard device configured as described above, when the key is depressed, the holder at the rear end portion of the key rises, and the repetition lever and the jack move upward together with the holder. Along with this, first, the repetition lever pushes up the hammer via the hammer protrusion portion and turns the hammer upward. Subsequently, the rear end portion of the repetition lever is stopped by abutting on a repetition stopper of the hammer support from below, so that the jack pushes up the hammer protrusion portion via the hammer push-up portion to turn the hammer upward. Then, when the hammer turns to a position immediately before pressing a key switch, the rear end portion of the rear arm of the jack abuts on the jack stopper of the hammer support from below, so that the hammer push-up portion of the jack comes out of the hammer protrusion portion (escapement). As a result of such escapement of the jack, the hammer is uncoupled from the action unit, and presses the key switch in a freely turning state to produce a piano sound. Note that, when the jack escapes, a sense of click is generated due to a change in the touch weight of the key, whereby a sense of let-off is obtained as the sense of touch of the player who plays the keyboard musical instrument.

### CITATION LIST

### Patent Literature

Patent Literature 1: JP 2024-93320 A

### SUMMARY

In the keyboard device described above, the following failures may occur due to problems at the time of manufacture. That is, when the action unit is attached to the rear end portion of the key at the time of manufacture, the holder may be misaligned in the front-rear direction with an appropriate position with respect to the key. For example, in a case where the holder is attached to the rear side of the appropriate position, the hammer protrusion portion of the hammer to be placed on the repetition lever may be located on the front side of the appropriate position. Since the upper surface of the repetition lever on which the hammer protrusion portion of the hammer is placed is formed so as to be inclined forward and downward, the position of the hammer in the key release state is lower, so that the maximum height that the hammer reaches when the hammer turns upward at the time of key depression is also lower. As a result, even if the key is fully depressed at the time of key depression, the hammer may not reach the cushion at the upper limit position, and there is a possibility that a sense of touch at the time of key depression becomes poor due to vibration of the hammer or the like, or a sound generation failure occurs as the hammer cannot appropriately press the key switch.

On the other hand, in a case where the holder is attached to the front side of the appropriate position, the position of the hammer in the key release state is higher, and thus, the hammer turns at a higher position than usual. As a result, before the key is fully depressed at the time of key depression, the hammer may reach the cushion at the upper limit position, and there is a possibility that a sense of touch at the time of key depression becomes poor, or a sound is generated earlier as the hammer presses the key switch earlier.

In the above manner, if the attachment position of the holder of the action unit is misaligned in the front-rear direction with the appropriate position, a sense of touch at the time of key depression may become poor, and the sound may be generated at the wrong time. Furthermore, in the keyboard device described above, since each key to which the action unit is attached is made of wood, the above-described problems are caused not only by an attachment error of the holder at the time of manufacture but also by an environmental change due to temperature, humidity, or the like, and a dimensional change of the key due to the lapse of time or the like.

The present invention has been made to solve the above-described problems, and it is an object of the present invention to provide a keyboard device for a keyboard musical instrument capable of obtaining an appropriate action of an action unit even in a case where a holder of the action unit attached to a rear end portion of a key is misaligned in a front-rear direction with an appropriate position at the time of manufacture or due to a change over time, and thereby obtaining a good sense of touch and an appropriate sound generation timing at the time of key depression.

In order to achieve the above object, an invention according to claim 1 includes a key which extends by a predetermined length in a front-rear direction and is swingable with a vicinity of a center in a length direction as a fulcrum, an action unit which is provided at a rear portion of the key and executes a predetermined action in conjunction with key depression of the key, a hammer support which is disposed on a rear side of the key, a hammer which extends by a predetermined length in the front-rear direction, is turnably supported at a rear end portion via a hammer support shaft extending in a right-left direction of the hammer support, is placed on the action unit via a hammer protrusion portion provided so as to protrude downward immediately on a front side of the hammer support shaft, and is driven upward via the action unit along with the key depression of the key, and a keyboard pillow which supports a rear end portion of the key from below in a key release state. The action unit includes a holder which is fixed to a rear end portion of the key, a repetition lever which is formed to have a predetermined shape extending in the front-rear direction, is turnably attached to the holder, places the hammer protrusion portion on an upper surface provided with a jack guide hole penetrating in an up-down direction and extending in the front-rear direction, and pushes up the hammer via the hammer protrusion portion to turn the hammer upward by moving upward along with the key depression of the key, and a jack which includes a hammer push-up portion extending in the up-down direction and a rear arm extending rearward from a vicinity of a lower end of the hammer push-up portion, and is turnably attached to the holder, and in which an upper end portion of the hammer push-up portion is inserted into the jack guide hole of the repetition lever from below and engaged with the jack guide hole of the repetition lever to be movable in the front-rear direction, and which pushes up the hammer via the hammer protrusion portion by the hammer push-up portion in a middle of upward moving of the repetition lever along with the key depression of the key to turn the hammer upward. The hammer support includes a repetition stopper which stops the repetition lever as a rear end portion of the repetition lever abuts on the repetition stopper from below while the repetition lever is pushing up the hammer, and a jack stopper which stops the jack as a rear end portion of the rear arm abuts on the jack stopper from below while the jack is pushing up the hammer, and turns the jack with the rear end portion of the rear arm that has abutted as a fulcrum to cause the hammer push-up portion of the jack to come out of the hammer protrusion portion of the hammer. The holder includes an abutment projection portion projecting downward. The keyboard pillow includes an inclined surface which is provided to be inclined forward and downward on a lower side of the holder and on which the abutment projection portion of the holder abuts from above in the key release state.

According to this configuration, the action unit is provided at the rear portion of the key, and the hammer, the rear end of which is turnably supported by the hammer support shaft of the hammer support, is placed on the action unit via the hammer protrusion portion immediately on the front side of the hammer support shaft. The action unit includes the holder fixed to the rear end portion of the key, and the repetition lever and the jack turnably attached to the holder. The hammer push-up portion of the jack is inserted into the jack guide hole of the repetition lever from below and engaged with the jack guide hole of the repetition lever to be movable in the front-rear direction, and the hammer is placed on the upper surface of the repetition lever provided with the jack guide hole via the hammer protrusion portion.

When the front end portion of the key is depressed at the time of key depression, the rear end portion of the key moves upward integrally with the holder of the action unit, and along with this, the repetition lever of the action unit moves upward and pushes up the hammer via the hammer protrusion portion to turn the hammer upward. While the repetition lever is pushing up the hammer, the rear end portion of the repetition lever abuts on the repetition stopper of the hammer support from below, so that the repetition lever is stopped. Further, after the repetition lever is stopped, the hammer push-up portion of the jack pushes up the hammer via the hammer protrusion portion and further turns the hammer upward. While the jack is pushing up the hammer, the rear end portion of the rear arm of the jack abuts on the jack stopper of the hammer support from below, so that the jack is stopped. The jack is turned with the rear end portion of the rear arm that has abutted as a fulcrum to cause the hammer push-up portion of the jack to come out of the hammer protrusion portion. That is, the jack escapes from the hammer. As a result of such escapement of the jack, the hammer is uncoupled from the action unit and the key, and turns upward in a freely turning state. When the jack escapes, a sense of click is generated due to a rapid increase or decrease in the touch weight of the key, whereby a sense of let-off is obtained as the sense of touch of the player who depresses the key.

Furthermore, according to the above configuration, in the key release state, the rear end portion of the key is supported from below by the keyboard pillow. Specifically, the rear end portion of the key is supported in a state where the abutment projection portion of the holder fixed to the rear end portion of the key abuts on the inclined surface inclined forward and downward of the keyboard pillow from above. In this manner, the inclined surface of the keyboard pillow which supports the rear end portion of the key from below via the abutment projection portion of the holder is inclined forward and downward. Therefore, for example, in a case where the holder is provided on the rear side of an appropriate position, the abutment projection portion of the holder is supported at a high position, and in a case where the holder is provided on the front side of the appropriate position, the abutment projection portion of the holder is supported at a low position. Accordingly, even in a case where the holder is misaligned in the front-rear direction with the appropriate position, the key in the key release state can be maintained in an appropriate posture. As a result, an appropriate action of the action unit can be obtained, whereby a good sense of touch and an appropriate sound generation timing can be obtained at the time of key depression.

An invention according to claim 2 is the keyboard device for a keyboard musical instrument according to claim 1, in which the keyboard pillow includes a molded product made of a synthetic resin.

According to this configuration, since the keyboard pillow includes a molded product made of a synthetic resin, it is possible to obtain a keyboard pillow with high dimensional accuracy, and as a result, it is possible to maintain the key whose rear end portion is supported by the keyboard pillow in the key release state in a favorable predetermined posture.

An invention according to claim 3 is the keyboard device for a keyboard musical instrument according to claim 2, in which a cushion is attached to the inclined surface of the keyboard pillow.

According to this configuration, the cushion is attached to the inclined surface of the keyboard pillow. Therefore, when the depressed key is released and the abutment projection portion of the holder fixed to the rear end portion of the key hits from above, the impact is alleviated by the cushion, and noise due to the impact can be prevented from occurring.

An invention according to claim 4 is the keyboard device for a keyboard musical instrument according to any one of claims 1 to 3, in which the abutment projection portion of the holder has a bottom surface formed to be inclined forward and downward.

According to this configuration, the bottom surface of the abutment projection portion of the holder is formed so as to be inclined forward and downward. Therefore, even in a case where the holder is misaligned in the front-rear direction with an appropriate position, the height of the rear end portion of the key can be maintained uniform in a stable state.

### BRIEF DESCRIPTION OF DRAWINGS

FIG. 1A is a perspective view illustrating a keyboard device for an electronic piano to which a keyboard device according to an embodiment of the present invention is applied when the keyboard device is viewed obliquely from the upper front;

FIG. 1B is a perspective view illustrating the keyboard device when viewed obliquely from the upper rear;

FIG. 2A is an enlarged perspective view corresponding to FIG. 1A and illustrating the right end portion of the keyboard device;

FIG. 2B is an enlarged perspective view corresponding to FIG. 1B and illustrating the right end portion of the keyboard device;

FIG. 3A is a perspective view illustrating a state in which a right side plate fitting is omitted and a white key and a black key at the right end remain in the keyboard device illustrated in FIG. 1A;

FIG. 3B is a right side view of the keyboard device;

FIG. 4A is a perspective view illustrating an action unit attached to a key and a hammer placed on the upper side of the action unit;

FIG. 4B is a perspective view illustrating the key, the action unit, and the hammer in an exploded manner;

FIG. 5A is a perspective view illustrating a hammer support;

FIG. 5B is a perspective view illustrating the hammer support in a partially cut-away state;

FIG. 6A is a front view illustrating the hammer support;

FIG. 6B is a cross-sectional view taken along line A-A;

FIG. 7A is an enlarged perspective view of the hammer and the action unit, illustrating a state in which components of the action unit are combined;

FIG. 7B is a perspective view illustrating the components of the action unit in an exploded manner;

FIG. 8 is a right side view illustrating the hammer;

FIG. 9 is a right side view illustrating a holder;

FIG. 10A is a right side view illustrating a repetition lever to which a bush is attached;

FIG. 10B is a right side view illustrating the repetition lever from which the bush is removed;

FIG. 11A is a front view illustrating the bush for the repetition lever in an enlarged manner;

FIG. 11B is a perspective view illustrating the bush for the repetition lever in an enlarged manner;

FIG. 12A is a right side view illustrating a jack to which a bush is attached;

FIG. 12B is a right side view illustrating the jack from which the bush is removed;

FIG. 13A is a front view illustrating the bush for the jack in an enlarged manner;

FIG. 13B is a perspective view illustrating the bush for the jack in an enlarged manner;

FIG. 14 is an enlarged right side view of the rear end portion of the keyboard device;

FIG. 15A is an explanatory view for sequentially describing the operation of the action unit and the hammer at the time of key depression, and is a view illustrating a key release state;

FIG. 15B is a view illustrating a state in which the repetition lever abuts on a repetition stopper at the time of key depression;

FIG. 16A is an explanatory view following FIG. 15B, and is a view illustrating a state in which the jack abuts on a jack stopper;

FIG. 16B is a view illustrating a state in which a hammer push-up portion of the jack comes out of a hammer protrusion portion;

FIG. 17A is an explanatory view following FIG. 16B, and is a view illustrating a state in which the front end portion of the key is depressed to the lowest position and the hammer abuts on a hammer stopper;

FIG. 17B is a view illustrating a state in which the hammer rebounds from the hammer stopper and is supported by the repetition lever;

FIG. 18A is an explanatory view following FIG. 17B, and is a view illustrating a state in which the depressed key is slightly returned and the hammer push-up portion of the jack moves to the lower side of the hammer protrusion portion; and

FIG. 18B is a view illustrating a state in which the key returns to the original key release state.

### DETAILED DESCRIPTION

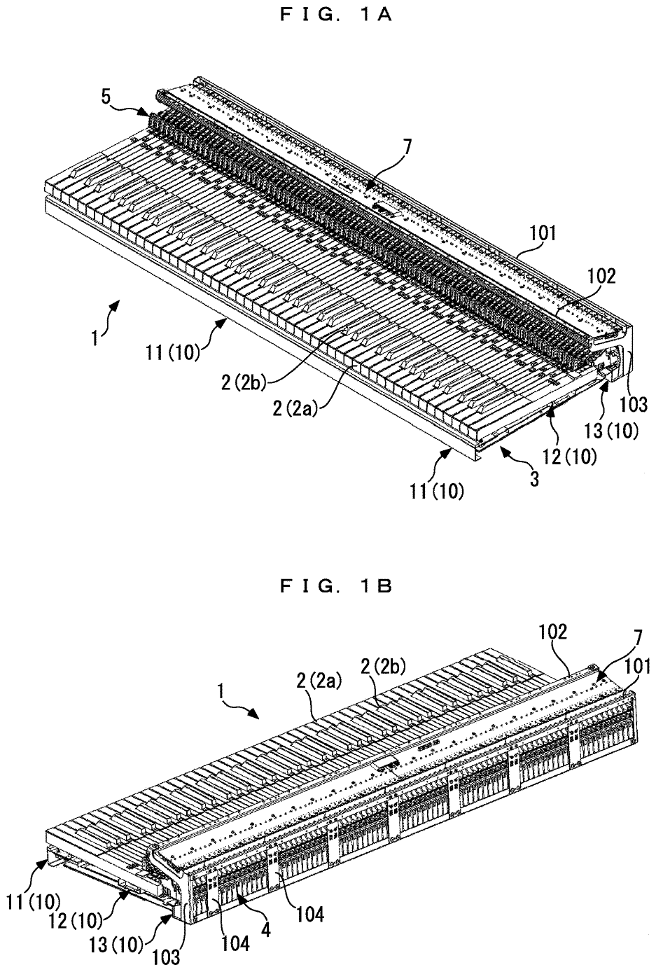

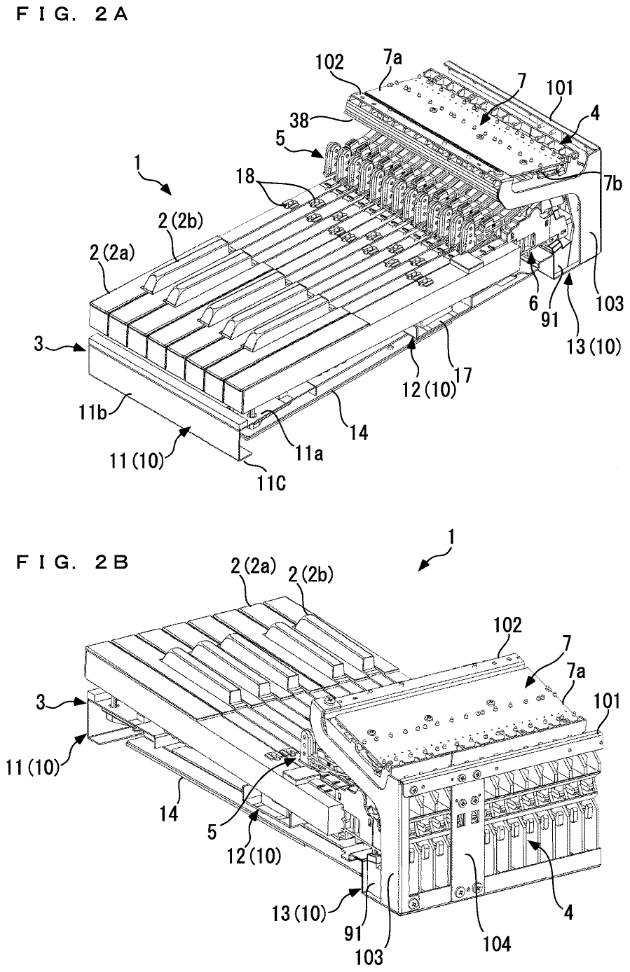

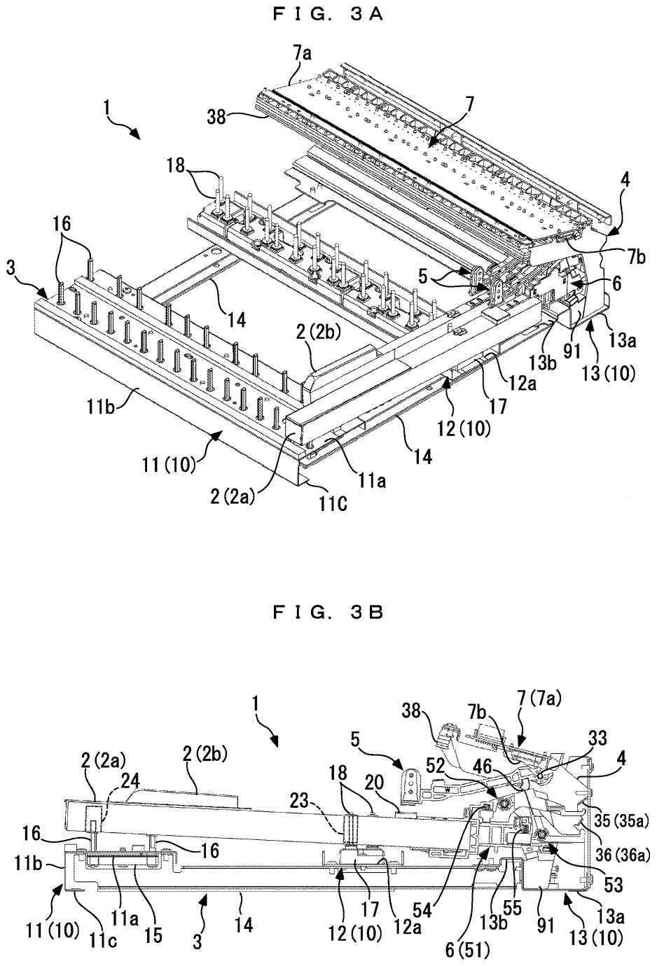

Hereinbelow, preferred embodiments of the present invention will be described in detail with reference to the drawings. FIGS. 1A and 1B each illustrate a keyboard device for an electronic piano to which a keyboard device according to an embodiment of the present invention is applied and in which an exterior case is omitted. FIG. 1A illustrates a state of the keyboard device when viewed obliquely from the upper front, and FIG. 1B illustrates a state of the keyboard device when viewed obliquely from the upper rear. FIGS. 2A and 2B correspond to FIGS. 1A and 1B, respectively, and illustrate the right end portion of the keyboard device in an enlarged manner. FIG. 3A illustrates a state in which a white key and a black key at the right end remain in the keyboard device illustrated in FIG. 1A, and FIG. 3B is a right side view of the keyboard device.

As illustrated in each of the drawings described above, the keyboard device 1 includes a large number of (88 in FIGS. 1A and 1B) keys 2 (52 white keys and 36 black keys) arranged in the right-left direction of the electronic piano, a keyboard chassis 3 supporting the keys 2, a hammer support 4 connected to the rear end portion of the keyboard chassis 3, a hammer 5 provided for each key 2 and turnably supported by the hammer support 4, an action unit 6 provided at the rear end portion of the key 2 and driving the hammer 5 upward along with key depression, a key switch 7 for detecting key depression information of the key 2, and the like. In the following description, as for the keys 2, in a case where the white key and the black key are distinguished from each other, they are referred to as a “white key 2a” and a “black key 2b”, respectively, and in a case where they are not distinguished, each of them is simply referred to as a “key 2”.

As illustrated in FIG. 3A, the keyboard chassis 3 is formed by assembling three support rails 10 including a front rail 11, a middle rail 12, and a rear rail 13, which extend in the right-left direction and which are disposed at predetermined spaces in the front-rear direction (right-left direction in FIG. 3B), and a plurality of (for example, five) reinforcing ribs 14 (only two ribs are illustrated in FIG. 3A), which extend in the front-rear direction and which are disposed at predetermined spaces in the right-left direction, in parallel crosses. The support rail 10 and the reinforcing rib 14 are made of an iron plate formed into a predetermined shape by, for example, punching and bending by pressing, and are connected to each other by screwing.

The front rail 11 includes a horizontal top plate portion 11a, a front plate portion 11b bent downward at a right angle from the front end portion of the top plate portion 11a, and a bottom plate portion 11c bent rearward at a right angle from the lower end portion of the front plate portion 11b. On the lower surface of the top plate portion 11a, a front keyframe 15 is fixed by screwing or the like. The front keyframe 15 is made of a synthetic resin, is formed to have a thick plate shape, and extends in the right-left direction over the entire front rail 11. On the front keyframe 15, a large number of front pins 16 are provided upright at front and rear positions corresponding to the white key 2a and the black key 2b in a state of penetrating the top plate portion 11a of the front rail 11 and being aligned in the right-left direction.

The middle rail 12 has a horizontal middle keyframe placement portion 12a, and the front end portion and the rear end portion thereof are bent upward at a right angle. On the middle keyframe placement portion 12a, a middle keyframe 17 is fixed by screwing or the like in a state of being placed. The middle keyframe 17 is made of a synthetic resin, is formed to have a thick plate shape, and extends in the right-left direction over the entire middle rail 12. On the middle keyframe 17, a large number of balance pins 18 are provided upright at front and rear positions corresponding to the white key 2a and the black key 2b in a state of being aligned in the right-left direction.

The rear rail 13 has a housing recess portion 13a which is opened upward and to which the lower portion of the hammer support 4 and a keyboard pillow 91 to be described below are fixed in a state of being housed therein, and a connection portion 13b which is bent at a right angle from the upper end portion of the front plate portion of the housing recess portion 13a and extends forward and to which the rear end portion of each rib 14 is connected.

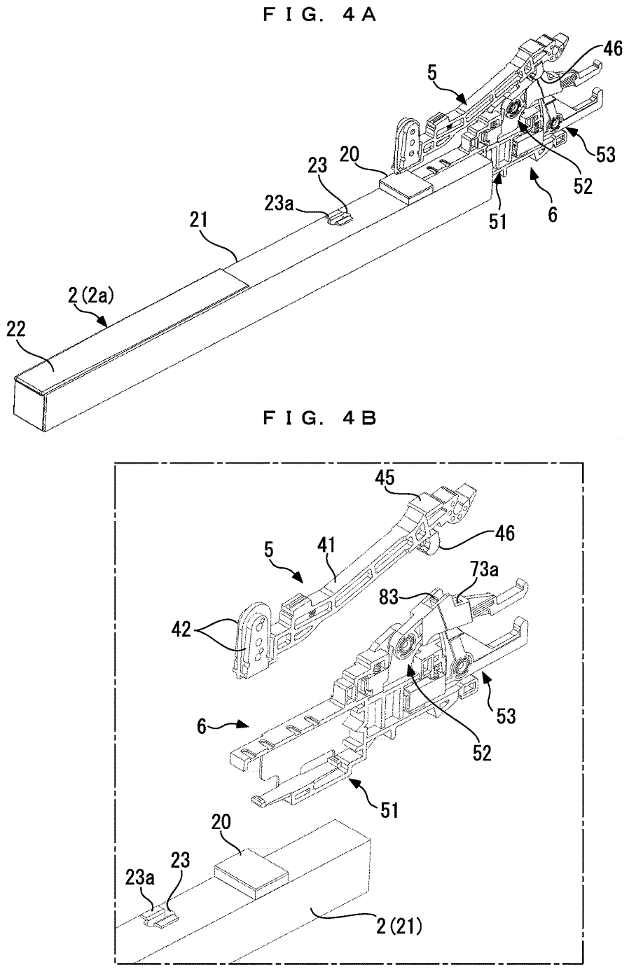

FIG. 4A illustrates the action unit 6 attached to the key 2 (the white key 2a in FIG. 4A) and the hammer 5 placed on the upper side of the action unit 6, and FIG. 4B illustrates the key 2, the action unit 6, and the hammer 5 in an exploded manner. As illustrated in FIGS. 4A and 4B, the key 2 includes a wooden key body 21 extending by a predetermined length in the front-rear direction and having a rectangular transverse cross section, and a synthetic resin key cover 22 bonded to the upper surface and the front surface of the front half portion of the key body 21. A balance pin hole 23 penetrating in the up-down direction is formed near the center in the length direction of the key body 21, and the key 2 is swingably supported by the balance pin 18 provided upright on the middle keyframe 17 via the balance pin hole 23.

The balance pin hole 23 is provided with a substantially circular hole in the vicinity of the lower surface of the key body 21, and the entire upper portion connected to the hole is formed to have a long hole shape extending in the length direction of the key body 21. In addition, a felt 23a is provided on the right and left inner surfaces of the balance pin hole 23 in order for the key 2 to smoothly slide with respect to the balance pin 18 when the key 2 swings. A cushion 20 is bonded to the upper surface of the key body 21 on the rear side of the balance pin hole 23, and the cushion 20 prevents the front end portion of the hammer 5 from directly hitting the key 2 at the time of maintenance or the like.

In addition, a front pin hole 24 (see FIG. 3B) opened downward is formed at a predetermined position of the front portion of the key body 21, and the front pin hole 24 is engaged with the front pin 16 provided upright on the front keyframe 15, thereby preventing the key 2 from moving in the right-left direction when swinging.

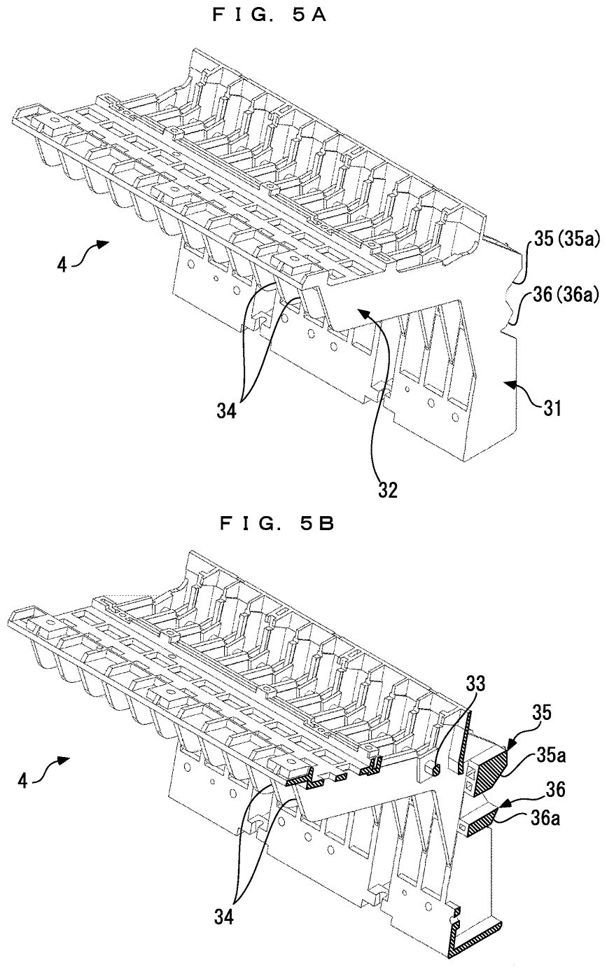

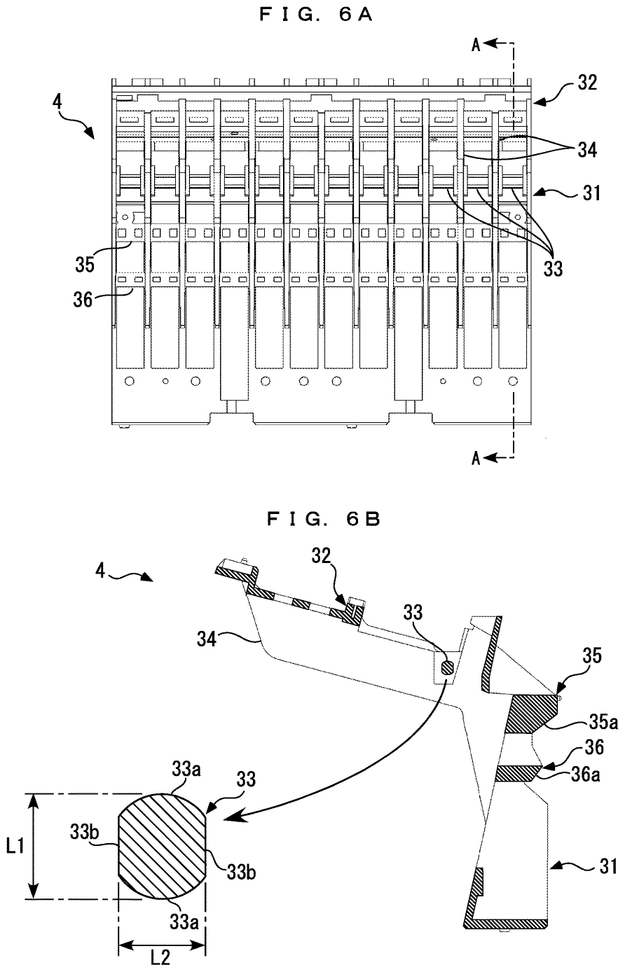

FIGS. 5A to 6B illustrate the hammer support 4. As illustrated in FIGS. 5A to 6B, the hammer support 4 includes a molded product made of a synthetic resin, and a plurality of molded products each corresponding to, for example, one octave are screwed to the rear rail 13 of the keyboard chassis 3 in a state of being connected to each other in the right-left direction. The hammer support 4 includes a hammer support portion 31 standing upright from the vicinity of the rear rail 13, a switch attachment portion 32 extending obliquely upward and forward from the upper end portion of the hammer support portion 31, and the like. A hammer support shaft 33 for turnably supporting each hammer 5 is provided at the upper end portion of the hammer support portion 31.

In addition, the hammer support 4 has a plurality of partition walls 34 that separate the adjacent hammers 5 at predetermined spaces in the right-left direction, and the hammer support shaft 33 extends in the right-left direction between the adjacent partition walls 34 and 34. As illustrated in an enlarged manner in FIG. 6B, the hammer support shaft 33 has a so-called oval cross-sectional shape in which two portions in the front and rear of the circle centered on the axial center of the hammer support shaft 33 are cut out.

Specifically, the outer peripheral surface of the hammer support shaft 33 includes a pair of upper and lower curved surface portions 33a and 33a and a pair of front and rear flat surface portions 33b and 33b extending between the curved surface portions 33a and 33a. In the hammer support shaft 33 configured as described above, the upper and lower curved surface portions 33a and 33a are set to have an arc shape having a diameter of length L1, while the distance between the front and rear flat surface portions 33b and 33b is set to length L2 shorter than length L1.

As illustrated in FIGS. 1A to 3B, the key switch 7 is attached to the switch attachment portion 32 of the hammer support 4. The key switch 7 includes a switch substrate 7a including a printed circuit board, and a switch body 7b including a rubber switch attached to the side of the switch substrate 7a close to the hammer 5 for each key 2.

As illustrated in FIGS. 5A to 6B, on the back side of the hammer support 4, a repetition stopper 35 is provided obliquely downward on the rear side of the hammer support shaft 33. The repetition stopper 35 is contacted by a repetition lever 52, to be described below, of the action unit 6 at the time of key depression, and stops the repetition lever 52. The repetition stopper 35 has an abutment surface 35a which is inclined forward and downward and on which the repetition lever 52 abuts. Note that a cushion such as a felt is attached to the abutment surface 35a in order to reduce noise and vibration when the repetition lever 52 abuts.

Furthermore, on the back side of the hammer support 4, a jack stopper 36 is provided below the repetition stopper 35. The jack stopper 36 is contacted by a jack 53, to be described below, of the action unit 6 at the time of key depression, and stops the jack 53. Similarly to the repetition stopper 35 described above, the jack stopper 36 has an abutment surface 36a which is inclined forward and downward and on which the jack 53 abuts. Note that a cushion such as a felt is attached to the abutment surface 36a as well in order to reduce noise and vibration when the jack 53 abuts.

As illustrated in FIGS. 1A to 3B, at the upper portion of the front end of the hammer support 4, a hammer stopper 38 is provided. The hammer stopper 38 is contacted by the hammer 5 from below when the hammer 5 turns upward, and prevents the hammer 5 from further turning. The hammer stopper 38 extends in the right-left direction over all the hammer supports 4, has a rectangular transverse cross section, and is made of a cushion having a predetermined thickness.

As described above, the plurality of (for example, eight) hammer supports 4 configured as described above are supported in a state of being arranged side by side in the right-left direction as the lower end portions thereof are connected to the rear rail 13, and in addition, predetermined portions thereof are connected by a plurality of fittings described below.

Specifically, as illustrated in FIGS. 1A to 2B, all the hammer supports 4 are supported by an upper rail 101 extending over the entire keyboard device 1 in the right-left direction and connecting the upper end portions on the back surface side of the hammer supports 4, an upper front rail 102 connecting the upper end portions on the front side of the hammer supports 4, two right and left side plate fittings 103 and 103 arranged at both right and left ends of the keyboard device 1 and connecting the rear rail 13, the upper rail 101, and the upper front rail 102 to each other by screwing, and a plurality of (seven in FIG. 1B) connection fittings 104 each extending in the up-down direction, arranged at spaces in the right-left direction, and connecting the rear rail 13 and the upper rail 101. Accordingly, all the hammer supports 4 can be held in a firm and stable state, and even when the hammer 5 strongly hits the hammer stopper 38 of the hammer support 4 at the time of key depression, deformation and vibration of each hammer support 4 can be prevented.

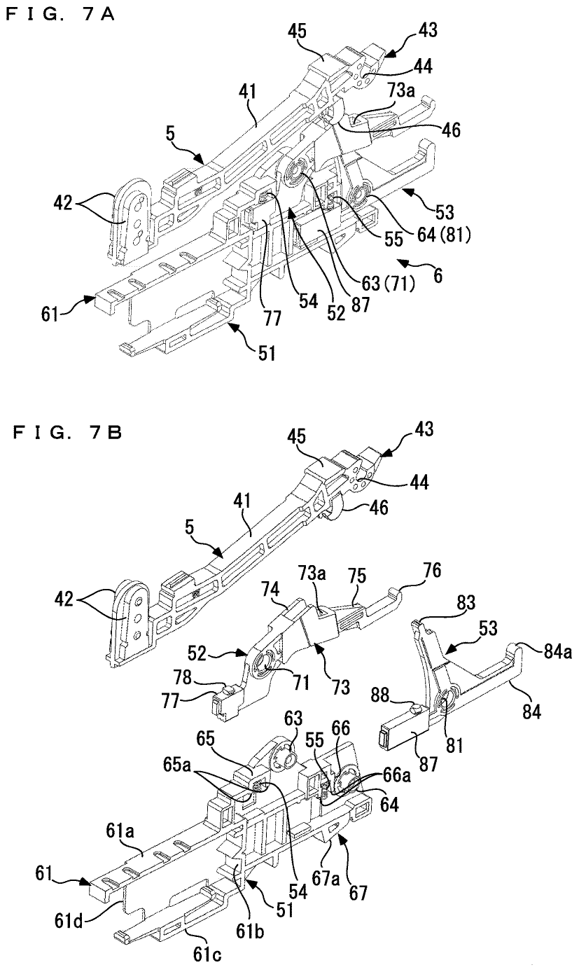

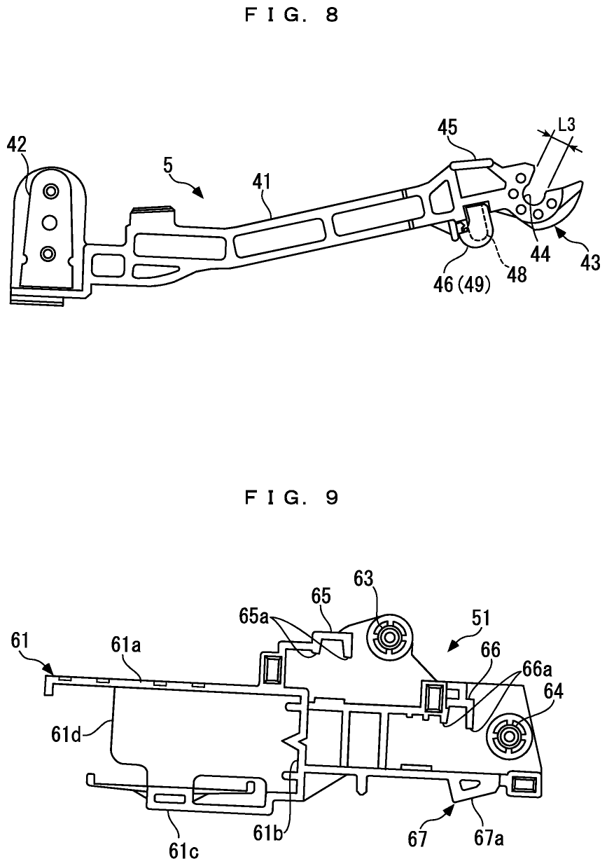

FIGS. 7A and 7B each illustrate the hammer 5 and the action unit 6. FIG. 7A illustrates a state in which the components of the action unit 6 are combined, and FIG. 7B illustrates a state in which the components of the action unit 6 are exploded. FIG. 8 is a right side view illustrating the hammer 5. As illustrated in FIGS. 7A to 8, the hammer 5 includes an arm-shaped hammer body 41 extending in the front-rear direction by a predetermined length, and two weight plates 42 and 42 attached to the front end portions of the right and left side surfaces of the hammer body 41. The hammer body 41 is made of a synthetic resin, and the weight plate 42 is made of a metal material such as iron having a relatively large specific gravity.

At the rear end portion of the hammer body 41, an engagement portion 43 that engages with the hammer support shaft 33 of the hammer support 4 is provided. In the engagement portion 43, an arc-shaped shaft hole 44 penetrating in the right-left direction and having a C-shaped side surface is formed so that the opening portion thereof expands outward. The shaft hole 44 has a slightly larger diameter than the diameter (length L1) of the upper and lower curved surface portions 33a and 33a of the hammer support shaft 33, and width L3 of the opening portion is slightly larger than length L2 between the front and rear flat surface portions 33b and 33b of the hammer support shaft 33 and smaller than length L1. The hammer 5 is detachably attached to the hammer support shaft 33 of the hammer support 4 via the opening portion of the shaft hole 44, and is turnably supported by the hammer support 4 by fitting the shaft hole 44 to the hammer support shaft 33.

In the rear portion of the hammer 5, a switch pressing portion 45 and a hammer protrusion portion 46 are provided above and below the immediate front side of the shaft hole 44, respectively. The switch pressing portion 45 has a flat upper surface, and presses the switch body 7b of the key switch 7 when the hammer 5 turns upward, thereby detecting key depression information of the key 2 corresponding to the hammer 5.

On the other hand, the hammer protrusion portion 46 corresponds to a shank roller of a hammer of a grand piano. This hammer protrusion portion 46 is formed by attaching a roller bush 49 made of an elastic material to a protrusion portion body 48 formed integrally with the hammer body 41.

Then, in the key release state, the hammer protrusion portion 46 is placed on a hammer placement portion 74 of the repetition lever 52, to be described below, of the action unit 6.

Next, the action unit 6 will be described. As illustrated in FIGS. 7A and 7B, the action unit 6 includes a holder 51 fixed to the rear end portion of the key 2, the repetition lever 52 and the jack 53 turnably attached to the holder 51, and a repetition spring 54 and a jack spring 55 that bias the repetition lever 52 and the jack 53 to turn the repetition lever 52 and the jack 53 in predetermined directions, respectively, both of which are coil springs.

FIG. 9 illustrates a right side view of the holder 51. As illustrated in FIGS. 9 and 7A and 7B, the holder 51 includes a molded product made of a synthetic resin and having a predetermined shape formed so as to extend in the front-rear direction. The holder 51 includes a key attachment portion 61 provided at the front portion and fixed to the rear end portion of the key 2, a repetition support shaft 63 provided at the upper end portion near the center in the front-rear direction and turnably supporting the repetition lever 52, and a jack support shaft 64 provided at the rear end portion and turnably supporting the jack 53.

The key attachment portion 61 has a side surface having a U shape by an upper wall 61a, a rear wall 61b, and a lower wall 61c, and is formed so that the left end portions of the walls are connected by a left side wall 61d. To attach the holder 51 to the rear end portion of the key 2, the upper wall 61a and the left side wall 61d of the holder 51 are fixed by adhesion in a state of being in contact with the upper surface and the left side surface of the rear end portion of the key body 21, respectively, and staples (not illustrated) are driven in from the upper side of the upper wall 61a and from the left side of the left side wall 61d of the holder 51. Thus, the holder 51 is firmly fixed to the rear end portion of the key body 21.

The repetition support shaft 63 and the jack support shaft 64 each have a cylindrical shape protruding rightward by a predetermined length and having a predetermined diameter. The repetition support shaft 63 is formed at a predetermined position higher than the jack support shaft 64.

In addition, the holder 51 is provided with a repetition spring stop portion 65 that stops the upper end portion of the repetition spring 54 at a predetermined position on the front side of the repetition support shaft 63. The repetition spring stop portion 65 has a U-shaped side surface opened downward, and is configured to immovably hold the upper end portion of the repetition spring 54. In addition, a lower end portion 65a of the repetition spring stop portion 65 also functions as a stopper which, when the repetition lever 52 turns at the time of key depression, prevents the repetition lever 52 from further turning as the front end portion of the repetition lever 52 abuts on the lower end portion 65a from below.

Further, the holder 51 is provided with a jack spring stop portion 66 that stops the upper end portion of the jack spring 55 at a predetermined position on the front side of the jack support shaft 64 between the repetition support shaft 63 and the jack support shaft 64. Similarly to the repetition spring stop portion 65 described above, the jack spring stop portion 66 has a U-shaped side surface opened downward, and is configured to immovably hold the upper end portion of the jack spring 55. In addition, a lower end portion 66a of the jack spring stop portion 66 also functions as a stopper which, when the jack 53 turns at the time of key depression, prevents the jack 53 from further turning as the front end portion of the jack 53 abuts on the lower end portion 66a from below.

In addition, at the rear portion of the lower surface of the holder 51, an abutment projection portion 67 is provided. The abutment projection portion 67 slightly projects downward and abuts on the keyboard pillow 91 to be described below from above in the key release state. The abutment projection portion 67 has on the bottom portion thereof an inclined surface 67a inclined forward and downward at a predetermined angle with respect to the horizontal plane.

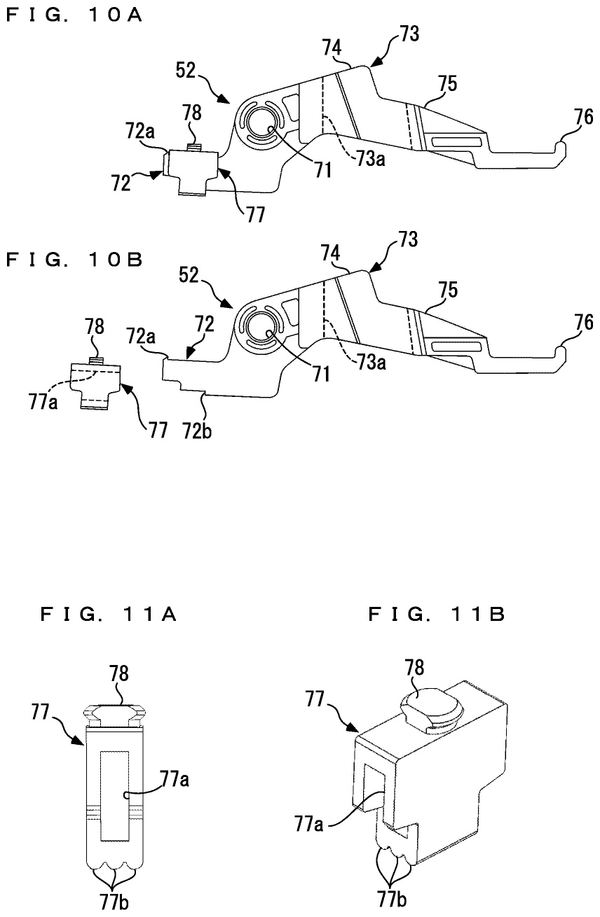

FIGS. 10A and 10B each illustrate a right side view of the repetition lever 52. FIG. 10A illustrates a state in which a bush 77 for the repetition lever to be described below is attached to the repetition lever 52, and FIG. 10B illustrates a state in which the bush 77 is removed from the repetition lever 52. The repetition lever 52 includes a molded product made of a synthetic resin and having a predetermined shape formed so as to extend in the front-rear direction. The repetition lever 52 includes a fitting hole 71 penetrating in the right-left direction and turnably fitted to the repetition support shaft 63 of the holder 51, a front arm 72 extending forward from the lower side of the fitting hole 71, and a hammer placement arm 73 formed to extend rearward from the rear side of the fitting hole 71, on which the hammer 5 is placed and with which the jack 53 is engaged.

The front arm 72 is configured such that the bush 77 for the repetition lever is attached easily and in a retaining state. Specifically, as illustrated in FIG. 10B, the front arm 72 is formed such that the upper surface thereof is horizontal and the bottom portion has a stepped shape of two steps, and the height dimension decreases toward the tip end (the left end of FIG. 10B). In addition, the tip end portion of the front arm 72 is provided with a barb 72a that protrudes upward and holds the bush 77 attached to the front arm 72 in a retaining state.

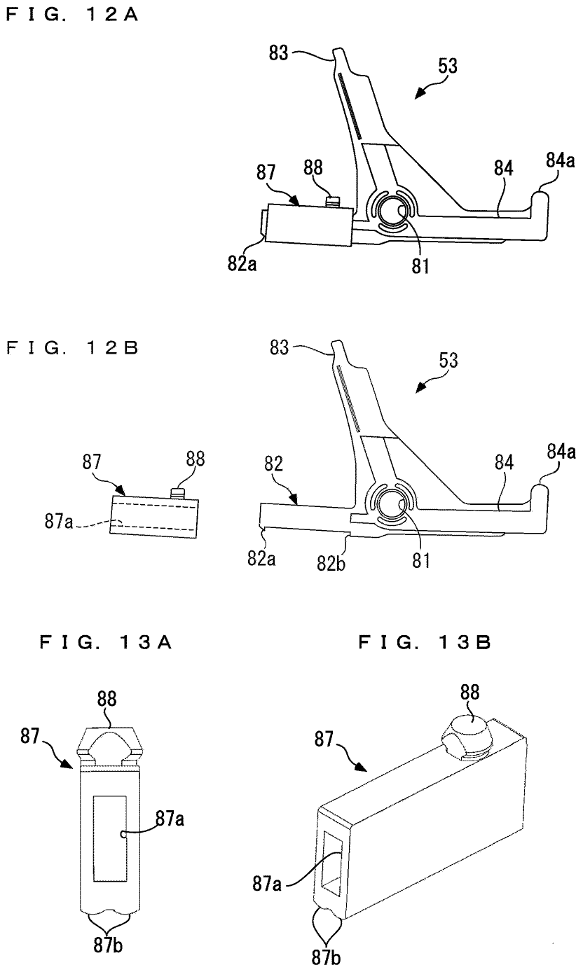

FIGS. 11A and 11B each illustrate the bush 77 for the repetition lever in an enlarged manner. FIG. 11A is a front view, and FIG. 11B is a perspective view. As illustrated in FIGS. 11A and 11B, the bush 77 includes a molded product made of a soft resin having elasticity and having a substantially T-shaped side surface. The bush 77 is provided with an attachment hole 77a which penetrates in the front-rear direction and through which the front arm 72 of the repetition lever 52 is inserted to attach the bush 77 to the front arm 72. The height dimension of the attachment hole 77a in the up-down direction is the same as that near the center in the length direction of the front arm 72.

At the center of the upper surface of the bush 77, a stop projection portion 78 that protrudes upward and stops the lower end portion of the repetition spring 54 is provided. The stop projection portion 78 is formed such that the upper half portion has a diameter slightly larger than the inner diameter of the repetition spring 54 and the lower half portion has a diameter smaller than the inner diameter of the repetition spring 54. In addition, the front and rear portions of the stop projection portion 78 are slightly cut out vertically. Further, on the lower surface of the bush 77, a plurality of (three in the present embodiment) lower projection portions 77b protruding downward and extending in the front-rear direction are provided side by side in the right-left direction.

To attach the bush 77 configured as described above to the front arm 72 of the repetition lever 52, the front arm 72 is inserted into the attachment hole 77a of the bush 77, and as illustrated in FIG. 10A, the barb 72a of the front arm 72 is exposed to the outside on the side opposite to the insertion side of the attachment hole 77a of the bush 77. Furthermore, in this case, in the bush 77, the lower end portion on the insertion side of the attachment hole 77a abuts on a step portion 72b of the bottom portion of the front arm 72 illustrated in FIG. 10B, to prevent the bush 77 from being further inserted into the front arm 72. By doing so, the bush 77 is easily attached to the front arm 72, and is firmly attached in a retaining state.

In the bush 77, to attach the repetition spring 54 to the stop projection portion 78 at the upper portion, the upper half portion of the stop projection portion 78 is press-fitted into the inner side of the lower end portion of the repetition spring 54 from below. By doing so, the lower end portion of the repetition spring 54 can be easily and firmly attached to the stop projection portion 78.

As illustrated in FIG. 10A, the hammer placement arm 73 of the repetition lever 52 has a hammer placement portion 74 whose side surface extends rearward and obliquely upward by a predetermined length from the fitting hole 71, and an extension portion 75 extending rearward and obliquely downward from the rear end portion of the hammer placement portion 74 and further extending rearward. In addition, the hammer placement arm 73 is provided with a jack guide hole 73a penetrating in the up-down direction and extending in the front-rear direction across the hammer placement portion 74 and the extension portion 75.

The rear end portion of the repetition lever 52 is provided with a protrusion portion 76 protruding upward. When the repetition lever 52 turns, the protrusion portion 76 abuts on the abutment surface 35a of the repetition stopper 35 of the hammer support 4 from below.

FIGS. 12A and 12B each illustrate a right side view of the jack 53. FIG. 12A illustrates a state in which a bush 87 for the jack to be described below is attached to the jack 53, and FIG. 12B illustrates a state in which the bush 87 is removed from the jack 53. The jack 53 includes a molded product made of a synthetic resin and having a predetermined shape. The jack 53 includes a fitting hole 81 penetrating in the right-left direction and turnably fitted to the jack support shaft 64 of the holder 51, a front arm 82 extending forward from the front side of the fitting hole 81, a hammer push-up portion 83 extending upward from the upper side of the fitting hole 81 by a predetermined length, and a rear arm 84 extending rearward from the rear side of the fitting hole 81.

The front arm 82 of the jack 53 is configured such that the bush 87 for the jack is attached easily in a retaining state. Specifically, as illustrated in FIG. 12B, the front arm 82 has an upper surface and a bottom surface that are parallel to each other and is provided with a barb 82a that protrudes downward and holds the bush 87 attached to the front arm 82 in a retaining state.

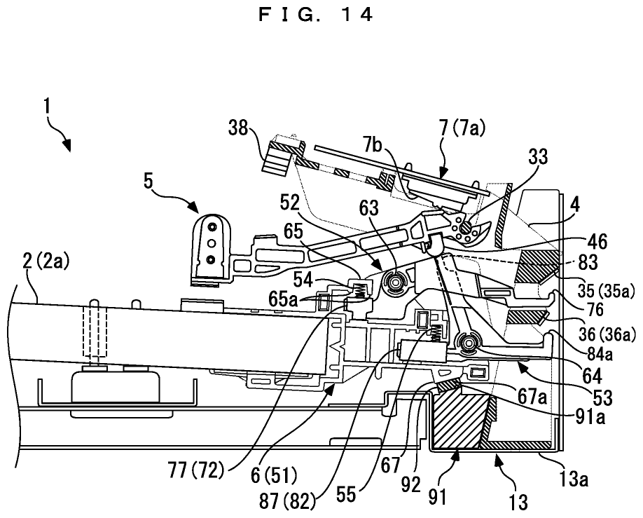

FIGS. 13A and 13B each illustrate the bush 87 for the jack. FIG. 13A is a front view, and FIG. 13B is a perspective view. As illustrated in FIGS. 13A and 13B, the bush 87 includes a molded product made of a soft resin having elasticity and having a horizontally long rectangular side surface. The bush 87 is provided with an attachment hole 87a which penetrates in the front-rear direction and through which the front arm 82 of the jack 53 is inserted to attach the bush 87 to the front arm 82. The height dimension of the attachment hole 87a in the up-down direction is the same as the height dimension between the upper surface and the bottom surface of the front arm 82.

On the upper surface of the bush 87, a stop projection portion 88 that protrudes upward and stops the lower end portion of the jack spring 55 is provided. The stop projection portion 88 has a truncated cone head portion at a position slightly higher than the upper surface of the bush 87. The head portion has an upper end portion having a diameter smaller than the inner diameter of the jack spring 55 and a lower end portion having a diameter slightly larger than the inner diameter of the jack spring 55. In addition, the front and rear portions of the stop projection portion 88 are slightly cut out vertically. Further, on the lower surface of the bush 87, a plurality of (two in the present embodiment) lower projection portions 87b protruding downward and extending in the front-rear direction are provided side by side in the right-left direction.

To attach the bush 87 configured as described above to the front arm 82 of the jack 53, the front arm 82 is inserted into the attachment hole 87a of the bush 87, and as illustrated in FIG. 12A, the barb 82a of the front arm 82 is exposed to the outside on the side opposite to the insertion side of the attachment hole 87a of the bush 87. Furthermore, in this case, in the bush 87, the lower end portion on the insertion side of the attachment hole 87a abuts on a step portion 82b of the bottom portion of the front arm 82 illustrated in FIG. 12B, to prevent the bush 87 from being further inserted into the front arm 82. By doing so, the bush 87 is easily attached to the front arm 82, and is firmly attached in a retaining state.

In the bush 87, to attach the jack spring 55 to the stop projection portion 88 at the upper portion, the head portion of the stop projection portion 88 is press-fitted into the inner side of the lower end portion of the jack spring 55 from below. By doing so, the lower end portion of the jack spring 55 can be easily and firmly attached to the stop projection portion 88.

As illustrated in FIG. 12A, the hammer push-up portion 83 extends obliquely upward and forward in a state of being inclined forward by a predetermined angle with respect to the front arm 82 and the rear arm 84 extending substantially horizontally in the front-rear direction. In addition, the upper end portion of the hammer push-up portion 83 is formed to have a smaller width in the front-rear direction than the portion lower than the upper end portion. The rear end portion of the rear arm 84 is provided with a protrusion portion 84a protruding upward. When the jack 53 turns, the protrusion portion 84a abuts on the abutment surface 36a of the jack stopper 36 of the hammer support 4 from below.

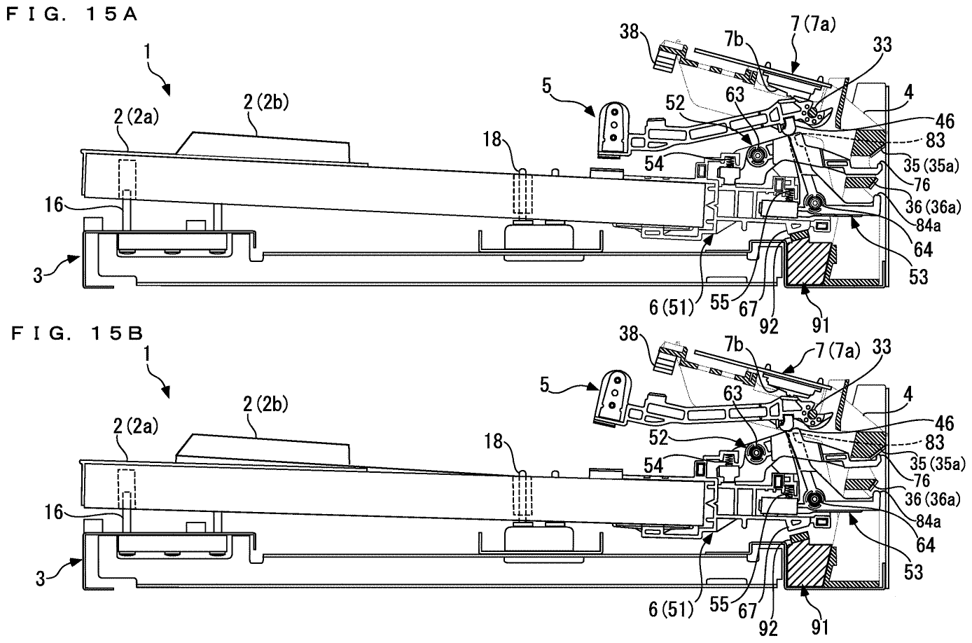

FIG. 14 is an enlarged right side view of the rear end portion of the keyboard device 1. As illustrated in FIG. 14, in the action unit 6 configured as described above, the hammer push-up portion 83 of the jack 53 is engaged in a state of being inserted into the jack guide hole 73a of the repetition lever 52 from below. Further, the front arm 72 of the repetition lever 52 is biased downward by the repetition spring 54 via the bush 77, while the front arm 82 of the jack 53 is biased downward by the jack spring 55 via the bush 87. By doing so, the repetition lever 52 and the jack 53 are biased in the counterclockwise direction in FIG. 14 around the repetition support shaft 63 and the jack support shaft 64, respectively.

As illustrated in FIG. 14, the keyboard pillow 91 that supports the rear end portion of the key 2 in the key release state from below is provided in the housing recess portion 13a of the rear rail 13 in the keyboard chassis 3. The keyboard pillow 91 includes a molded product made of a synthetic resin, and similarly to the above-described hammer support 4, a plurality of molded products each corresponding to, for example, one octave are screwed to the housing recess portion 13a of the rear rail 13 in a state of being connected to each other in the right-left direction. In addition, the keyboard pillow 91 has on the upper end portion thereof an inclined surface 91a inclined forward and downward at a predetermined angle with respect to the horizontal plane. A cushion 92 extending in the right-left direction and having a horizontally long rectangular transverse cross section and a predetermined thickness is attached to the inclined surface 91a by adhesion. In the key release state, the abutment projection portion 67 of the holder 51 in the action unit 6 of the key 2 is placed on the cushion 92 on the keyboard pillow 91 from above.

Here, the repetition spring 54 and the jack spring 55 in the action unit 6 provided for each key 2 will be described. As described above, the keyboard device 1 includes the 88 keys 2, and the 88 keys 2 are categorized as a low sound range, a middle sound range, a next middle sound range, and a high sound range in order from the low sound side to the high sound side. Specifically, key numbers (Key No.) of 1 to 88 are assigned to all the 88 keys from the low sound side to the high sound side, and in general, the keys 2 are categorized as any of the sound ranges as follows.
Low sound range: Key No. 1-15
Middle sound range: Key No. 16-32
Next middle sound range: Key No. 33-63
High sound range: Key No. 64-88

In the four sound ranges divided as described above, the repetition spring 54 in the action unit 6 is set as follows. For example, the spring constant of the repetition spring 54 in the action unit 6 provided for the key 2 corresponding to the low sound range is set to be higher by 10%, the spring constant of the repetition spring 54 in the action unit 6 provided for the key 2 corresponding to the middle sound range is set to be higher by 5%, and the spring constant of the repetition spring 54 in the action unit 6 provided for the key 2 corresponding to the high sound range is set to be lower by 10% than the spring constant of the repetition spring 54 in the action unit 6 provided for the key 2 corresponding to the next middle sound range (predetermined reference sound range). By doing so, it is possible to reliably lift a hammer having a different weight for each sound range at the time of key release, and it is possible to obtain a sense of touch and repeated strike capability equivalent to those of a grand piano.

Note that the above-described setting of the spring constant is an example, and the spring constant of the low-sound-side sound range may be set to be higher by 0 to 10% and the spring constant of the high-sound-side sound range may be set to be lower by 0 to 10% than the spring constant of the repetition spring 54 in the next middle sound range. In this manner, by finely setting the spring constant of the repetition spring 54 for each sound range, the above-described action and effect can be obtained more reliably.

Further, in each action unit 6, the spring constant of the repetition spring 54 (hereinbelow appropriately referred to as a “spring constant K1”) is set to be higher than the spring constant of the jack spring 55 (hereinbelow appropriately referred to as a “spring constant K2”). More specifically, the spring constant K2 of the jack spring 55 has a minimum value necessary for turning the jack 53 that has escaped to the original position side, while the spring constant K1 of the repetition spring 54 is set to 1.5 to 10 times the spring constant K2 of the jack spring 55 (1.5·K2≤K1≤10·K2). For example, in the case of K1<1.5·K2, the spring strength of the repetition spring 54 is insufficient, and the hammer 5 may not be appropriately lifted by the repetition lever 52. On the other hand, in the case of K1>10·K2, the spring strength of the repetition spring 54 is excessive, and the sense of touch of the key 2 may become poor.

Therefore, by setting the spring constant K1 of the repetition spring 54 and the spring constant K2 of the jack spring 55 so as to satisfy 1.5·K2≤K1≤10·K2, it is possible to obtain senses of touch and performance more similar to those of a grand piano.

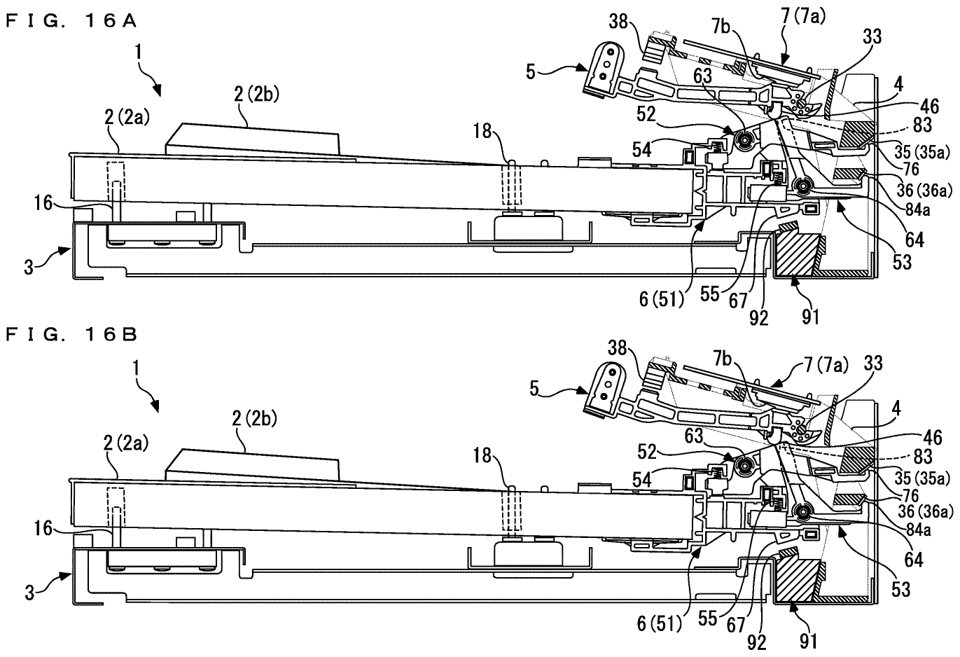

Next, operations of the action unit 6 and the hammer 5 when the key 2 (white key 2a) is depressed will be described with reference to FIGS. 15A to 18B.

FIG. 15A illustrates the keyboard device 1 in the key release state. In this key release state, the hammer 5 is placed on the hammer placement portion 74 of the repetition lever 52 via the hammer protrusion portion 46, and the upper end portion of the hammer push-up portion 83 of the jack 53 faces the hammer protrusion portion 46 with a gap.

When the front end portion of the key 2 is depressed from the key release state, the key 2 swings forward and downward about the balance pin 18, and the rear end portion of the key 2 moves upward. Along with this, the action unit 6 also moves upward integrally with the rear end portion of the key 2, and the hammer 5 is pushed up by the repetition lever 52 via the hammer protrusion portion 46. This causes the hammer 5 to turn upward (clockwise in FIG. 15A) about the hammer support shaft 33.

Subsequently, when the key depression progresses and the action unit 6 moves upward, as illustrated in FIG. 15B, the protrusion portion 76 of the rear end portion of the repetition lever 52 abuts on the abutment surface 35a inclined forward and downward of the repetition stopper 35 in the hammer support 4 from below. Accordingly, while the rear end portion of the repetition lever 52 is stopped, the upper end portion of the hammer push-up portion 83 of the jack 53 abuts on the hammer protrusion portion 46 from below. Accordingly, the hammer 5 is pushed up by the hammer push-up portion 83 of the jack 53 and further turns upward.

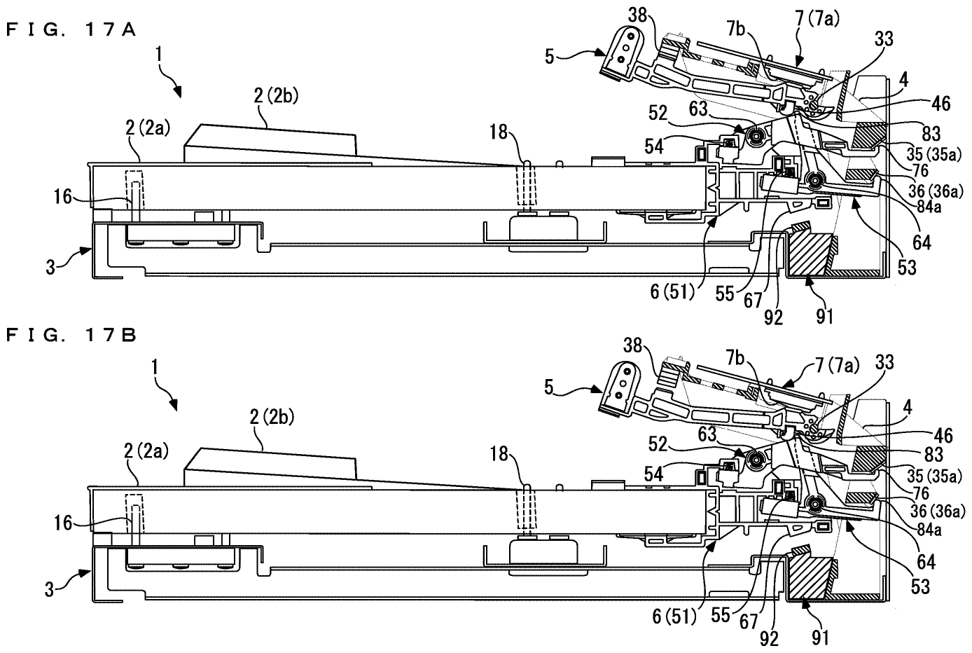

Subsequently, when the key depression further progresses and the action unit 6 further moves upward, as illustrated in FIG. 16A, the protrusion portion 84a of the rear end portion of the rear arm 84 in the jack 53 abuts on the abutment surface 36a inclined forward and downward of the jack stopper 36 in the hammer support 4 from below. Accordingly, the jack support shaft 64 moves upward in a state where the rear end portion of the rear arm 84 is stopped, so that the jack 53 turns in the clockwise direction of FIG. 16A with the rear end portion of the rear arm 84 as a fulcrum. As a result, as illustrated in FIG. 16B, the upper end portion of the hammer push-up portion 83 of the jack 53 moves rearward and comes out of the hammer protrusion portion 46 of the hammer 5. As a result of such escapement of the jack 53, the hammer 5 is uncoupled from the action unit 6 and the key 2, and turns further upward in a freely turning state.

Note that, when the jack 53 escapes, a sense of click is generated due to a rapid increase or decrease in the touch weight of the key 2, whereby a sense of let-off is obtained as the sense of touch of the player who depresses the key.

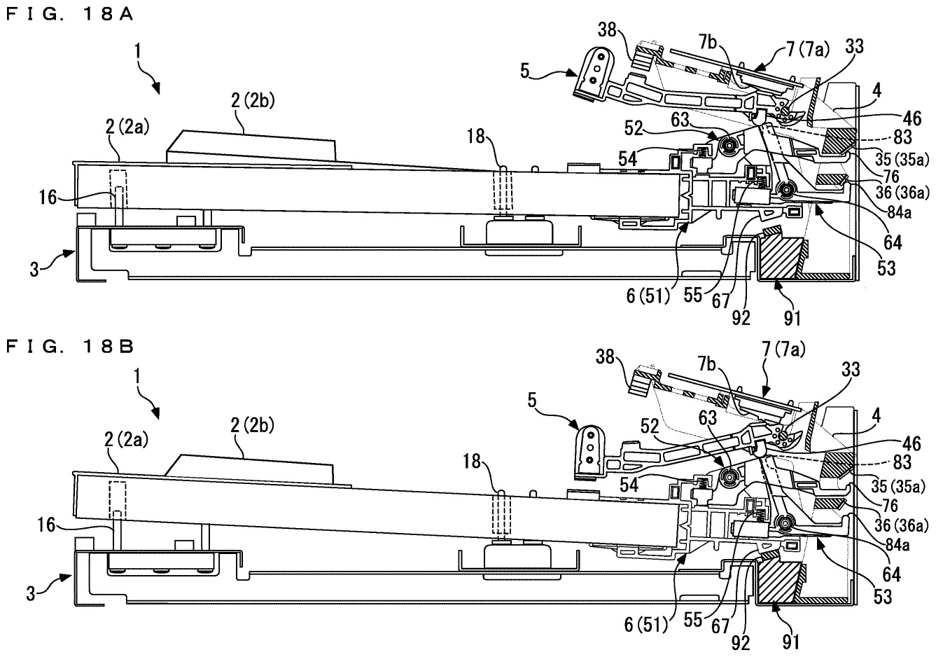

FIG. 17A illustrates a state in which the front end portion of the key 2 is depressed to the lowest position and the hammer 5 turned upward abuts on the hammer stopper 38 at the upper portion of the front end of the hammer support 4. In this case, the front portion of the hammer body 41 of the hammer 5 abuts on the hammer stopper 38 from below, so that the hammer 5 is prevented from further turning. In addition, in this case, the switch pressing portion 45 of the hammer 5 presses the switch body 7b of the key switch 7 from below to turn on the key switch 7, whereby key depression information of the key 2 corresponding to the turning speed of the hammer 5 or the like is detected and output to a sound production control device (not illustrated). Then, the sound production control device outputs a piano sound from a loudspeaker (not illustrated) of the electronic piano on the basis of the key depression information.

In the above case, the front arm 72 of the repetition lever 52 abuts on the lower end portion 65a of the repetition spring stop portion 65 from below via the bush 77, and the front arm 82 of the jack 53 abuts on the lower end portion 66a of the jack spring stop portion 66 from below via the bush 87. Since each of the bushes 77 and 78 is made of a soft resin having elasticity, it is possible to prevent noise caused by the abutment from being generated.

FIG. 17B illustrates a state immediately after the hammer 5 abuts on the hammer stopper 38, specifically, a state in which the hammer 5 rebounds from the hammer stopper 38 and turns downward (counterclockwise) toward the original position before the key is depressed. In this case, the hammer 5 is placed on the hammer placement portion 74 of the repetition lever 52 via the hammer protrusion portion 46. This prevents the hammer 5 from turning downward more than necessary.

FIG. 18A illustrates a state in which the depressed key 2 is slightly (for example, ⅓ of the keyboard depth) returned by the release of the key. When the key 2 is released from the state illustrated in FIG. 17B described above, as illustrated in FIG. 18A, the front end portion of the key 2 moves upward while the rear end portion thereof moves downward, and accordingly, the action unit 6 moves downward integrally with the rear end portion of the key 2. In this case, the front arm 72 of the repetition lever 52 is pushed down by the biasing force of the repetition spring 54, whereby the repetition lever 52 turns in the counterclockwise direction in FIG. 18A about the repetition support shaft 63. Similarly, the front arm 82 of the jack 53 is pushed down by the biasing force of the jack spring 55, whereby the jack turns in the counterclockwise direction in FIG. 18A about the jack support shaft 64. As a result, as illustrated in FIG. 18A, the upper end portion of the hammer push-up portion 83 of the jack 53 moves to the lower side of the hammer protrusion portion 46 of the hammer 5, and as a result, the hammer 5 can be driven by the action unit 6 even in a state where the key 2 does not completely return to the position in the key release state.

Then, when the key 2 is completely released, as illustrated in FIG. 18B, the key 2, the hammer 5, and the repetition lever 52 and the jack 53 of the action unit 6 each return to the original position in the key release state.

As described above in detail, according to the present embodiment, the keyboard device 1 including the key 2, the action unit 6, and the hammer 5 described above can achieve a similar action to that of a grand piano, whereby senses of touch and performance equivalent to those of a grand piano can be obtained at the time of performance.

In addition, the inclined surface 91a inclined forward and downward is provided at the upper portion of the keyboard pillow 91, and the abutment projection portion 67 of the holder 51 of the action unit 6 abuts from above in the key release state. Therefore, even in a case where the holder 51 is misaligned in the front-rear direction with an appropriate position, the key 2 in the key release state can be maintained in an appropriate posture. As a result, an appropriate action of the action unit 6 can be obtained, whereby a good sense of touch and an appropriate sound generation timing can be obtained at the time of key depression.

Note that the present invention is not limited to the above-described embodiments, and can be carried out in various modes. In addition, detailed configurations and the like of the keyboard device 1, the key 2, the hammer support 4, the hammer 5, and the action unit 6 described in the embodiment are merely examples, and can be appropriately changed within the scope of the gist of the present invention.

What is claimed is:

1. A keyboard device for a keyboard musical instrument, comprising:
a key which extends by a predetermined length in a front-rear direction and is swingable with a vicinity of a center in a length direction as a fulcrum;
an action unit which is provided at a rear portion of the key and executes a predetermined action in conjunction with key depression of the key;
a hammer support which is disposed on a rear side of the key;
a hammer which extends by a predetermined length in the front-rear direction, is turnably supported at a rear end portion via a hammer support shaft extending in a right-left direction of the hammer support, is placed on the action unit via a hammer protrusion portion provided so as to protrude downward immediately on a front side of the hammer support shaft, and is driven upward via the action unit along with the key depression of the key; and
a keyboard pillow which supports a rear end portion of the key from below in a key release state, wherein the action unit includes
a holder which is fixed to a rear end portion of the key,
a repetition lever which is formed to have a predetermined shape extending in the front-rear direction, is turnably attached to the holder, places the hammer protrusion portion on an upper surface provided with a jack guide hole penetrating in an up-down direction and extending in the front-rear direction, and pushes up the hammer via the hammer protrusion portion to turn the hammer upward by moving upward along with the key depression of the key, and
a jack which includes a hammer push-up portion extending in the up-down direction and a rear arm extending rearward from a vicinity of a lower end of the hammer push-up portion, and is turnably attached to the holder, and in which an upper end portion of the hammer push-up portion is inserted into the jack guide hole of the repetition lever from below and engaged with the jack guide hole of the repetition lever to be movable in the front-rear direction, and which pushes up the hammer via the hammer protrusion portion by the hammer push-up portion in a middle of upward moving of the repetition lever along with the key depression of the key to turn the hammer upward,
the hammer support includes
a repetition stopper which stops the repetition lever as a rear end portion of the repetition lever abuts on the repetition stopper from below while the repetition lever is pushing up the hammer, and
a jack stopper which stops the jack as a rear end portion of the rear arm abuts on the jack stopper from below while the jack is pushing up the hammer, and turns the jack with the rear end portion of the rear arm that has abutted as a fulcrum to cause the hammer push-up portion of the jack to come out of the hammer protrusion portion of the hammer,
the holder includes an abutment projection portion projecting downward, and
the keyboard pillow includes an inclined surface which is provided to be inclined forward and downward on a lower side of the holder and on which the abutment projection portion of the holder abuts from above in the key release state.

2. The keyboard device for a keyboard musical instrument according to claim 1, wherein the keyboard pillow includes a molded product made of a synthetic resin.

3. The keyboard device for a keyboard musical instrument according to claim 2, wherein a cushion is attached to the inclined surface of the keyboard pillow.

4. The keyboard device for a keyboard musical instrument according to claim 1, wherein the abutment projection portion of the holder has a bottom surface formed to be inclined forward and downward.
